(19) United States
(12) Patent Application Publication
(10) Pub. No.: US 2010/0047534 A1
(43) Pub. Date: Feb. 25, 2010

(54) LAMINATE COMPRISING A SUBSTRATE AND A BARRIER LAYER, AND A PROCESS FOR PREPARATION THEREOF

(76) Inventors: Shahab Jahromi, Maastricht (NL); Constantinus Simon Maria Liebregts, Helmond (NL)

Correspondence Address: NIXON & VANDERHYE, PC, 901 NORTH GLEBE ROAD, 11TH FLOOR, ARLINGTON, VA, 22203, US

(21) Appl. No.: 12/524,606

(22) PCT Filed: Jan. 14, 2008
(86) PCT No.: PCT/EP08/00219

§ 371 Date: Nov. 5, 2009

(30) Foreign Application Priority Data
Jan. 29, 2007 (EP) 07001827.0
May 24, 2007 (EP) 07010342.9

(51) Int. Cl. B32B 3/10; B32B 9/00; B32B 27/00; B32B 29/00; B32B 5/16

(52) U.S. Cl. 428/195.1; 428/704; 428/523; 428/480; 428/537.5; 428/323

(57) ABSTRACT

The invention relates to a laminate comprising two plastic films and in between a crystalline triazine layer, the laminate having a lamination strength of about 2 N/inch or more as measured in a 90 degree tensile testing at 30 mm/min. The laminate can be used for packaging, such as carton based fruit juice and diary products packaging; retortable packaging, displays and the like.

The invention relates to a laminate comprising two plastic films with good barrier and adhesion properties. The invention further relates to a process for the preparation thereof.

Laminates are used in the packaging, electronic and other industries. Often, the laminates need good barrier properties like low oxygen or water vapor transmission rates. Plastic or paper films need to be coated with one or more layers improving the barrier properties. Yet, the adhesion between the films need to be sufficiently high. Substrates, for example polyolefin or polyester films coated with a metal or metal oxide, like e.g. aluminium, aluminium oxide, magnesium oxide or silicium oxide are known. The film with barrier properties is generally further laminated with e.g. a further polyolefin film while using an adhesive, or with extrusion lamination. These laminates are for example used in the packaging or electronic industry. Such laminates can have good barrier properties. However the metal layers that are used to enhance the barrier properties are non-transparent, cause environmental concern as they cause difficulties in recycling, and its contents is not micro-waveable. Metal oxide layers that are used to enhance barrier properties are easily damaged, expensive and require high level operators to reliably produce laminates. PVDC type of barrier films cause environmental concerns because of its chlorine content. EVOH type of barrier films are highly moisture sensitive.

One specific example of the use of a laminate in packaging is a carton or paper based package for e.g. liquid diary products and fruit juice. Generally, these packages have on the outside a PE film on a paper or cardboard, and on the inside, a PE-Aluminium-PE layer, a PE-EVOH-PE layer, a PE-Nylon-PE layer or only a PE layer laminated on the paper or cardboard. After preparation of a large, printed laminated web, carton based packages are folded and sealed from the web.

Another specific example of the use of certain laminates in packages is a so-called retortable packaging. This package is—with its final content—subjected to sterilizing conditions (for example slightly above 120° C. for 30 min up to for example 3 hr at 130° C. in a steam atmosphere). Such laminates require specific plastic films (as for example PE is not able to withstand these temperatures) and specific adhesives.

Object of the invention is to provide a laminate having good barrier properties and a good lamination strength, which is microwaveable but is not requiring high investment costs.

It is another object of the invention to provide a laminate with a barrier layer that is good enough to suit certain liquid food applications that may not require high performance and expensive barrier coatings, such as for UHT milk.

It is yet another object of the invention to provide a laminate with good barrier properties suitable in carton based packaging.

It is another object of the invention to provide a laminate for electronic applications.

It is a further object of the invention to provide a laminate suitable in retortable packaging.

One or more of the above objects are achieved with the current invention, providing a laminate comprising a substrate and a plastic film and in between a crystalline triazine layer, the laminate having a lamination strength of about 2 N/inch or more as measured in a 90 degree tensile testing at 30 mm/min.

Such laminate has outstanding barrier and durability properties, also under humid conditions. Furthermore, the laminates of the present invention can be used in packaging for microwaveable food applications, and can be easily recycled.

It was unexpected that the crystalline triazine layer in the laminate is insensitive to moisture, and even causes a decrease of the water vapor transmission rate. This was unexpected because a triazine barrier layer as top-coat is moisture sensitive, leading even to a strong decrease of the oxygen transmission barrier if measured at 85% RH.

Furthermore, it appears that the crystalline triazine layer has printability characteristics. Generally, printing causes a decrease in barrier properties. The present laminate has good final properties.

In a further embodiment of the present invention, the laminate comprises an adhesive layer between the crystalline triazine layer a plastic film.

In a further embodiment, the laminate comprises a pattern or figure on the crystalline triazine layer.

In a further embodiment, a film is directly extruded on the crystalline triazine layer, which may be printed.

In a further embodiment, the packaging comprises a PET substrate, crystalline triazine layer, poly-olefin layer, paper or cardboard layer and a further polyolefin layer.

In a further embodiment, the laminate is a retortable laminate, comprising plastic layers independently chosen from PP, PET and Polyamide.

The thickness of the crystalline triazine layer as formed on the substrate in the vapour-depositing step depends on its intended purpose, and can thus vary within wide limits. Preferably, the thickness of the layer is about 100 μm or less, more preferably about 10 μm or less, and even more preferably about 1 μm or less as with such lower thickness the transparency is improved. The thickness may be for example about 500 nm or less for cost reasons. The minimum thickness is preferably about 2 nm or more, more preferably about 10 nm or more, and even more preferred about 100 nm or more as such thickness improves the protective properties. For example, the thickness can be about 200 or 300 nm or more.

The crystalline triazine layer may be a single layer, it is however also possible that on the crystalline triazine layer further layers are present, for example further layer of triazine, a printing, a further polymer layer and/or a cured resin layer.

A further embodiment of the invention relates to a laminate comprising a layer of crystalline triazine further comprising a cured resin layer, which resin before cure comprised an azine-formaldehyde or phenol-formaldehyde resin.

In one embodiment of the present invention, the cured resin forms a coating, more preferably a protective coating.

In another embodiment of the present invention, the cured resin functions as an adhesive layer in a laminate. This is particularly preferable if an adhesive is necessary. The adhesive in such case is used both for its adhesive properties, as for improving the properties of the melamine barrier layer.

Preferably, the resin further comprises a film forming polymer.

The film forming polymer may be cross-linkable or substantially non-reactive. Preferably, the polymer is cross-linkable.

In one preferred embodiment of the invention, the polymer is able to react with the azine-formaldehyde or phenol-formaldehyde resin.

In another preferred embodiment of the invention, the resin comprised a further crosslinker able to react with the film forming polymer and preferably also with the azine or phenolic resin.

In another preferred embodiment, the laminate with barrier properties substantially retains its barrier properties upon printing. For example, the substrate film comprising a layer of crystalline triazine with a protective compound has a retention of oxygen barrier upon printing of 70% or better, preferably of 90% or better.

The present invention further relates to a process for making laminates with barrier properties by
a) providing a film substrate
b) applying a crystalline triazine layer
c) applying a resin composition p0 d) at least partly curing the resin composition
to obtain a substrate with a crystalline triazine layer and a cured resin.
and applying a further film after step c or d, or applying a film with a resin composition as step (c), to obtain a laminate with at least a crystalline triazine layer and a cured resin.

Azine resins are known in the art. Examples of azines include urea; melamine, benzguanamine and glycouril, which optionally can be partly alkylated. Phenol is well known, and phenol-formaldehyde resins can be made with phenol, alkylphenols, bisphenols, chlorinated phenols and the like.

In one embodiment of the invention, it is preferred to use an azine resin, as these resins generally are water-white, so no color is caused by the coating. Preferred azines are melamine, urea and mixtures of these. In a preferred embodiment of the invention, the azine resin comprises hexamethylolmelamine, or alkylated derivatives therefrom like hexamethylmethylolmelamine.

The azine or phenol resins are made by reacting formaldehyde with the azine or phenol. Generally, the reaction is performed in water, more in particular a water/formaldehyde mixture. As water is not a preferred solvent for use in the coating of the crystalline triazine, it is preferred to remove substantially all the water, and use the resin as 100% solid, or replace water with another solvent. It is in particular preferred, to use alkoxylated azine or phenol resins. In these resins part, or all of the methylolgroups are etherified with an alcohol, generally a primary alcohol. In one embodiment of the invention the methylol groups are only partially etherified, as such resins can be more reactive, which is in particular an advantage for low-temperature curing on heat sensitive substrates.

In a preferred embodiment, the azine- or phenol-formaldehyde resins are substantially 100% solid, or dissolved in non-water solvents.

In a further preferred embodiment, the azine- or phenol-formaldehyde resins are partially etherified with an alkylalcohol compound. Preferably, the alkylalcohol compound has 1-24 carbon atoms, prefrably 1-12, and most preferably 1-4 carbon atoms. Examples of alkylalcohol compounds include, but are not limited to, methanol, ethanol, 1-propanol, 2-propanol, n-butanol, 2-butanol, i-butanol, t-butanol, n-pentanol, cyclohexanol, dodecanol and the like.

As solvent in the resin composition, the common solvents can be used. It is preferred to have a low amount of water in the solvent. Preferably, the amount of water in the solvent is about 4 wt % or less, preferably about 1 wt % or less. It is furthermore preferred to have the amount of alcohol compound low as well. Preferably, the amount of alcohol compound is about 20 wt % or less, preferably, about 10 wt % or less. Generally, some alcohol compound will be present as solvent for the alkylated formaldehyde resin and/or as solvent for catalysts and the like. Preferably, the solvents comprise hydrocarbon based solvents. Suitable hydrocarbon based solvents include; xylene, ethylbenzene, naphta-cuts, toluene, n-hexane, octane and the like. Other suitable solvents include esters like ethyl-acetate, methoxy-propylacetate, diethyl-ester of butanedicarboxylic acid, ketones like ethyl-methylketone, acetone and the like. However, esters and ketones my be less preferred as they may adversely effect the triazine layer. The esters and ketones preferably are present in about 20% of the solvent or less, more preferably about 10 wt % of the solvent or less.

Preferably no solvent is used, or if a solvent is used, preferably, hydrocarbon based solvents like aromatic or aliphatic solvent is used for about 50 wt % or more, preferably for about 70% or more, and most preferably about 85% or more.

The azine or phenolic resin (the preferably etherified azine-formaldehyde or phenol-formaldehyde resin) can be used as such, preferably with a catalyst. In this case, about 90 wt % or more of the resin composition is the azine or phenolic resin.

In a preferred embodiment of the invention, a further polymer is used with the azine or phenol resin. This polymer may be a crosslinkable resin; or non-crosslinkable polymer.

In a preferred embodiment, the amount of azine or phenolic resin is about 3 wt % or more of the resin composition (the organic solids), preferably about 5 wt % or more, more preferably about 8 wt % or more, and even more preferably about 15 wt % or more. If another polymer is present, it is preferably present in about 10 wt % or more, preferably about 30 wt % or more, and even more preferably about 50 wt % or more.

In one embodiment of the invention, the further polymer is a polyester, polyether, acrylic polymer, polycarbonate, polyhydrocarbon or mixtures and/or copolymers of these. Suitable examples of such polymers include, but are not limited to, alkyd and modified alkyd resins; modified alkyd being acrylated or epoxydized alkyds, saturated polyester; acrylic modified polyester; acrylic resin, polyethers (like polyethyleneoxide; polypropyleneoxide, polytetrahydrofuran, poly(methyl)tetrahydrofuran, ethyleneoxide-butyleneoxide copolymers, ethylene-oxide-propyleneoxide copolymers); polycarbonate; PC-PPO copolymers; TMP-tri/hexa-caprolacton; alkoxylated pentaerytritol, ethoxylated BPA, acrylamide resin; OH-functional acrylic resins; epoxy-esters; epoxy functional phenolic resin or polyester-phenolic resin; hydroxylated polybutylene, hydroxylated C9 resins, hydroxylated C5-resins, and maleic acid anhydride grafted hydrocarbon resins. Further, polymers based on natural materials like cellulose oligomers can be used.

Preferably, the number average molecular weight of the further polymer is about 50000 or lower, preferably about 20000 or lower, and about 500 or higher, preferably about 1000 or higher.

Preferably, the further polymer has reactive groups and can form a cross-linked network. In one embodiment of the invention, the further polymer is reactive with the azine or phenolic resin. Preferably, the further polymer has reactive hydroxyl groups. Preferably, the hydroxyl value is about 3 or higher, preferably about 20 or higher. Generally, the OH-value will be about 200 or lower, preferably about 150 or lower. Generally, the acid value will be about 50 or lower, preferably about 10 or lower.

Suitable examples of non-crosslinkable resins are for example acrylic resins, methyl-cellulose, hydrocarbon resins (tackifyers), and the like.

As additives, the resin composition may comprise stabilizers, flow-agents, wetting agents, shielding agents, coloring agents, anti-blocking agents, adhesion promoters, anti-static agents, anti-fouling agents like fluorinated materials, silicon fluids, acrylic polymers, tackiness agents to make film sealable and the like. These additives generally will constitute about 0.1 wt % or more of the resin composition, often about 1 wt % or more. Generally, the amount will be about 20 wt % or less, preferably about 10 wt % or less.

The resin composition may further comprise fillers, or solid additives, like nanoparticles, clay, silicon, antistatic, carbon, AlOx for hardness and the like. The solid additives are not added in the calculations on resin, solvent and the like, as these particles are largely non-reactive. The amount of solid additives may be about 5 wt % or more, preferably about 10 wt % or more, and can be as high as 200 % by weight or less relative to the amount of resin, preferably about 100% by weight or less.

The resin composition preferably contains a catalyst to increase the cure speed and/or to lower the curing temperature.

In one embodiment, the resin composition comprises sufficient catalyst to achieve suitable cure for the azine or phenolic resin at 120° C. within 10 min. Preferably, the cure is sufficient at 120° C. in about 5 min or less. This embodiment is for example suitable if a PET carrier is used.

In another embodiment, the resin composition comprises sufficient catalyst to achieve suitable cure at 70° C. within 20 min, preferably within 10 min, and more preferably within 5 min. This embodiment is for example suitable if a PP carrier is used.

In another embodiment of the present invention, the resin composition comprises compounds for a dual cure. For example, the resin may be cured with UV light with if the resin contains ethylenically unsatured constituents, and with heat, to cure the azine or phenolic formaldehyde resin. Alternatively, part of the hydroxyl-functions may be crosslinked with isocyanate, and another part with heat, to cure the azine or phenolic formaldehyde resin. Alternatively, part of the compounds may be cured through an acid/epoxy or amine/epoxy reaction, and the other part by with heat, to cure the azine or phenolic formaldehyde resin. A dual cure mechanism may be particularly advantageous if the resin composition is used as the adhesive for the second film.

Generally, the viscosity of the resin composition at 23° C. will be about 0.1 Pa·s or higher, preferably about 1 Pa·s or higher. Generally, the viscosity will be about 50 Pa·s or lower, preferably about 10 Pa·s or lower as measured on a viscosimeter.

The resin composition can be applied with a gravure coater or by other known means. Preferably, the resin composition is applied at a thickness of about 100 nm or more, preferably about 1 μm or more. Generally, the thickness will be about 100 μm or less, preferably about 10 μm or less. Suitable thickness can be for example 1.5, 2, 3 or 4 μm.

Curing can be achieved by heating the substrate with the resin composition in an oven, or by infra-red irradiation.

In one embodiment of the invention, the protective coating is post-cured on the carrier at 20-60° C.; as the methylol-etherification reaction proceeds to further cure at these temperatures.

In a further embodiment of the present invention, the laminate comprises a crystalline triazine layer on a plastic film, which further comprises a cured resin composition, and which has an adhesive layer between the cured resin composition and a further plastic film.

In a further embodiment, the laminate comprises a pattern or figure on the cured resin on the crystalline triazine layer.

In a further embodiment, a film is directly extruded on the crystalline triazine layer, which may be printed, and which may comprise a further resin layer.

In a further embodiment, the invention relates to a packaging comprises a PET substrate, crystalline triazine layer which is protected with a reactive compound, a poly-olefin layer, paper or cardboard layer and a further polyolefin layer.

In a further embodiment, the invention relates to a laminate being a retortable laminate, comprising plastic layers independently chosen from PP, PET and Polyamide, a crystalline triazine layer. The laminate further will comprise an adhesive which is suitable to withstand retorting conditions. The adhesive may comprise the protective compound, or the laminate may comprise a protective coating and a retortable adhesive.

In a preferred embodiment of the invention, the laminate with barrier properties is sealable.

The crystalline triazine layer according to the invention may comprise in principle, any triazine compound, for example melamine, melam, melem, or melon. Preferably, the triazine compound is melamine.

Preferably the composite layer, when laminated at the side of the crystalline triazine layer with an adhesive and a plastic film is able to exhibit a lamination strength of about 2.5 N/inch or more, more preferably of about 3 N/inch or more, even more preferably of about 3.5 N/inch or more as measured with a tensile testing apparatus at 30 mm/min and at 90 degree. Generally, the upper limit of the lamination strength is not critical, but generally, this will be about 20 N/inch or less. The lamination of the composite layer for testing preferably is done with an appropriate urethane adhesive and laminated with a 10 μm thin polyethylene film. Thereafter, the lamination strength of the two films can be measured, and the failure mode can be observed. An appropriate adhesive is an adhesive that has such adhesion strength that the failure mode is not observed on the adhesion layer. The adhesion may be so high that the plastic film breaks. The value of the force necessary to break a film can in that case be taken as value for adhesion.

The substrate comprises a material that serves as carrier, and this generally will be a plastic or paper in the form of a film or web.

Flexible packaging materials generally are based on film or sheet like materials, hereinafter named film.

The composite layer according the invention, in particular the ones with a film as substrate may be used as such, but can also be applied on plastic, paper, cardboard, and the like.

In one embodiment of the invention, the layer is part of a packing for food and beverage products. Suitable food and beverage products include, but are not limited to coffee beans or milled coffee beans, beer, fruit juice, tomato ketchup, milk, cheese, prepared food and the like. The packaging can also be used for other products, such as for personal care and pharmaceutical products.

In another embodiment of the invention, the laminate or composite layer is used in or on displays or other electronic products, preferably flexible electronics products. One example of an electronic flexible product is a flexible display.

The barrier properties and/or the adhesion of the triazine layer can improve if the substrate is treated first with a primer layer. As the primer various types of compounds can be used. Examples include UV curable monomers such a acrylates and epoxies and various types of thermoset resins such as epoxies, isocyanates or polyester based adhesives. It is also possible to use chemical vapour deposition (CVD) methods to apply the primer such as parylene. The application of the primer can occur in-line (in the vacuum chamber) by first applying the primer, for example by vaporization, atomisation or CVD followed by deposition of the triazine compound, or off-line, i.e applying the primer outside the vacuum chamber. The combination of in-line and off-line methods using different types of primers and adhesives is also possible. To achieve higher barrier properties, this process can be repeated many times to produce a composite structure consisting of the base substrate (for example PET), primer, triazine layer, primer, triazine layer, primer and so on. When the primer is applied on top of the triazine layer, it has an additional function to protect the layer against action of humidity and mechanical wear. In this case the choice of primer is important, i.e. the primer can be chosen in such a way that the triazine layer can have even barrier for water vapour.

The substrate film may consist of a homogeneous material, or it may itself be non-homogeneous or a composite material. The substrate film may comprise various layers. Preferably, the film comprises a polymeric material. Examples of polymeric compounds are thermoplastic compounds and thermosetting compounds. Suitable examples of thermoplastic compounds include polyolefins, polyolefin-copolymers, polyvinylalcohol, polystyrenes, polyesters and polyamides. Suitable examples of such polymers include HD or LD polyethlylene (PE), LLD polyethylene, ethylene-propylene copolymers, ethylene-vinylacetate copolymer, polyproplylene (PP) and polyethylene terephtalate (PET). These thermoplastic compounds are often used in the form of a film, either as such or oriented; such orientation may be biaxial, such as for example biaxially oriented polypropylene film (BOPP) and biaxially oriented polyethylene terephthalate (BOPET). The film may also comprise a layer of paper.

The substrate with the crystalline melamine layer can be printed with methods known in the art such as for example flexography, Gravure or letterpress printing. Suitable inks can be used, such as for example solvent or UV-curable inks. Printing can also be performed on the laminate.

The substrate with the crystalline melamine layer will be further processed into a laminate. The further lamination step can be done by applying an adhesive, and further applying a film, or can be done by direct extrusion lamination. As an adhesive, solvent based adhesives or solventless systems can be used. In a preferred embodiment of the invention, the adhesive has a good adhesion to the melamine grains, and has a high strength, thereby aiding the coherency of the crystalline melamine layer. Suitably, the adhesive has a low expansion, high Tg, high crosslink density and a high intrinsic water barrier. Examples of adhesives include various type of UV—or thermal curable resins based on acrylates, epoxies, isocyanates, polyester, and melamine formaldehyde resins (as described above). In another embodiment of the invention, the direct extrusion lamination is performed at a relatively low temperature. A low temperature saves energy and improves barrier characteristics. Generally, extrusion lamination is performed at about 400° C. to oxidise the extruded film in order to improve adhesion in other systems. It appeared that such high temperature is not necessary, so, preferably, the extrusion lamination is performed at a temperature of about 300° C. or lower, even more preferable about 250° C. or lower, and most preferred about 200° C. or lower.

The composite layer according the invention has favorable barrier properties, for example a low oxygen transmission rate (OTR) and a low water vapor transmission rate (WVTR), and is sufficient wear resistant. Therefore, the composite layer of the invention can be used as such in printing and laminating.

The OTR is generally measured in an atmosphere of 20-30° C. and between 0% and 85% RH. The preferred values generally depends on the substrate. In case the substrate is biaxially oriented polypropylene (BOPP), the OTR generally will be about 400 cc/m²·24 h·MPa or less, preferably about 300 cc/m²·24 h·MPa or less and even more preferred about 200 cc/m²·24 h·MPa or less. Generally, in case of BOPP, the OTR will be about 20 cc/m²·24 h·MPa or higher, and for example may be about 50 cc/m²·24 h·MPa or higher. The OTR can be measured with suitable apparatus, such as for example with an OXTRAN 2/20 manufactured by Modern Control Co. In case the substrate is a PET film, the OTR generally will be about 50 cc/m²·24 h·MPa or less, preferably about 30 cc/m²·24 h·MPa or less and even more preferred about 10 cc/m²·24 h·MPa or less. Generally, in case of PET, the OTR will be about 0.3 cc/m²·24 h·MPa or higher, and for example may be about 0.5 or 1 cc/m²·24 h·MPa or higher.

Water vapor permeability (WVTR) can measured with a PERMATRAN 3/31 manufactured by Modern Control Co, in an atmosphere of 25-40° C. and between 50 and 90% RH. The preferred values will depend on the substrate. For example for BOPP the WVTR is generally about 3 g/m²·24 h or less, preferably about 2 g/m²·24 h or less, and more preferably about 1 g/m²·24 h or less. Generally, the vapor permeability will be about 0.1 g/m²·24 h or more, for example about 0.2 g/m²·24 h or more. For example for PET, the WVTR is generally about 8 g/m²·24 h or less, preferably about 7 g/m²·24 h or less, and more preferably about 4 g/m²·24 h or less. Generally, the vapor permeability will be about 0.5 g/m²·24 h or more, for example about 2 g/m²·24 h or more.

Preferably, the laminate has an OTR and WVTR also for other substrates which conform to the values given in the former two paragraphs.

The composite layer, optionally further processed by for example printing and laminating, can be applied as or to all kind of packing materials, for example paper, sheet and films. The packing material protects very well its content from for example oxygen, in this way increasing shelf life of for example food products or personal care products or protecting electronic components from oxygen attack.

In one embodiment, the laminate comprises a PET or BOPP film as substrate, a crystalline triazine layer as barrier layer, the laminate further comprising on the crystalline triazine layer a pattern or figure and an adhesive and thereon a further film, which may be a polyolefin film, such as preferably a PE film. In another preferred embodiment, the polyolefin film has reverse printing instead of direct printing on the triazine layer.

A triazine comprising layer and a process for making such layer is described in WO2004/101662. In WO2004/101662 a process is described wherein in a vapor deposition step a triazine compound, preferably melamine, is deposited on a substrate, at reduced pressure, the temperature of the substrate being below the temperature of the vaporized triazine. WO2004/101662 suggests that prior to or during the vapour-depositing step, the substrate may be treated with plasma, corona, UV radiation, electron beam, or a reactive gas such as water in order to create reactive groups on the surface of the substrate, and thereby improve the adhesion of the layer to the substrate.

Preferably, the substrate is kept at a temperature of about 50° C. or lower.

Vapour-depositing as such is a process known to the skilled person. As is known, a vapour-depositing step is often carried out at a reduced pressure, i.e. a pressure below atmospheric pressure. In the process according to the invention, the pressure preferably is below about 1000 Pa, preferably below about 100 Pa even more preferably below about 1 Pa, more preferably below about 1×10⁻² Pa. It was found, surprisingly, that the properties of the composite material, such as the barrier properties, can be even further improved by reducing the pressure at which the vapour-depositing step is carried out even further, preferably to about 4×10⁻³ Pa or below. More preferably, the vapour-depositing step is carried out at a pressure of about 2×10⁻³ Pa or below or about 1×10⁻³ Pa or below; in particular, the vapour-depositing step is carried out at a pressure of about 5×10⁻⁴ Pa or below, or about 1×10⁻⁴ Pa or below; more in particular, the vapour-depositing step is carried out at a pressure of about 5×10⁻⁵ Pa or below, or about 1×10⁻⁵ Pa or below; most preferably, the vapour-depositing step is carried out at a pressure of about 5×10⁻⁶ Pa or even of about 1×10⁻⁶ Pa or below.

During the vapour-depositing step, the temperature of the substrate is about −60° C. or higher, preferably about −30° C. or higher, and even more preferable about −20° C. or higher, and most preferable about −15° C. or higher. The temperature of the substrate generally will be about +125° C. or lower, preferably about +100° C. or lower, even more preferably about +80° C. or lower, and most preferably about 30° C. or lower. The temperature of the substrate is defined herein as the temperature of the part of the substrate that is not being vapour-deposited. For example, if the vapour-depositing step is done on a film which is guided over a temperature-controlled coating drum, the temperature of the substrate is the temperature at which the coating drum is controlled, thus the temperature of the surface section of the film that is in immediate contact with the coating drum. In such a case, and in view of the fact that the to be deposited compounds often have a much higher temperature than 125° C., it will typically occur—as is known—that the temperature of the side of the substrate that is being deposited is higher than the temperature of the side that is not being deposited.

Methods to ensure that the substrate has a defined temperature are, as such, known. One such a known method of ensuring that the substrate has a defined temperature is applicable in case there is at least one section, plane or side of the substrate where no layer is to be vapour-deposited; the said section, plane or side can then be brought into contact with a cooled or heated surface to bring the temperature to a desired level and keep it there. As an example, it is known that in case the substrate is a film and the vapour-depositing step is executed as a semi-continuous or continuous process whereby the layer will be deposited on one side of the film, the said film can be guided over a temperature-controlled roll, also known as coating drum, in such a fashion that the other side of the film—where no layer will be deposited—is in contact with the temperature-controlled roll before and/or during and/or following the vapour-depositing step.

One of the effects of the temperature difference between the melamine vapour and the substrate, combined with the number of nucleation points, is that the grain size of the crystalline melamine layer can be influenced. The grain size can also be changed by pressure; the lower pressure the smaller the grain size or melamine flux, i.e. the amount of vaporised melamine, more melamine giving smaller grains. Furthermore, the grain size can be influenced by continuous (role-to-role) or static deposition on the substrate, and the evaporator design. In a preferred embodiment of the invention, the deposition process is affected in such a way that the grain size of the crystalline melamine layer is relatively large, as that improves in particular the barrier characteristics under humid conditions. Preferably the grain size is about 200 nm or larger, more preferably about 300 nm or larger. For example, the grains are about 400 nm or larger in average diameter. Generally, the grains will be about 1000 nm or smaller, preferably about 700 nm or smaller, as that allows faster processing.

In another preferred embodiment, the crystalline melamine layer is aged in a humid atmosphere. It appeared that aging in an e.g. 85% RH atmosphere, an improvement was observed when the melamine barrier properties were thereafter measured in a dry atmosphere again. Aging can for example be done in an moist atmosphere ((70%-100% RH) above 0° C., preferably at about 20° C. or higher, such as for example at 30 or 40° C. Generally, the temperature will be 100° C. or lower, preferably about 60° C. or lower for practical reasons. Higher temperatures may be used if one chooses to use a pressurized chamber. The useful time period can be determined by the skilled person by measuring the OTR after aging.

Both the use of large grain size and the use of aging can be performed on any crystalline triazine barrier layer, being on film, rigid substrate, film with metal or metal-oxide layer, and in laminates made therewith. The use of large grain size and aging may in particular be effective in rigid packaging such as bottles, and in films for displays.

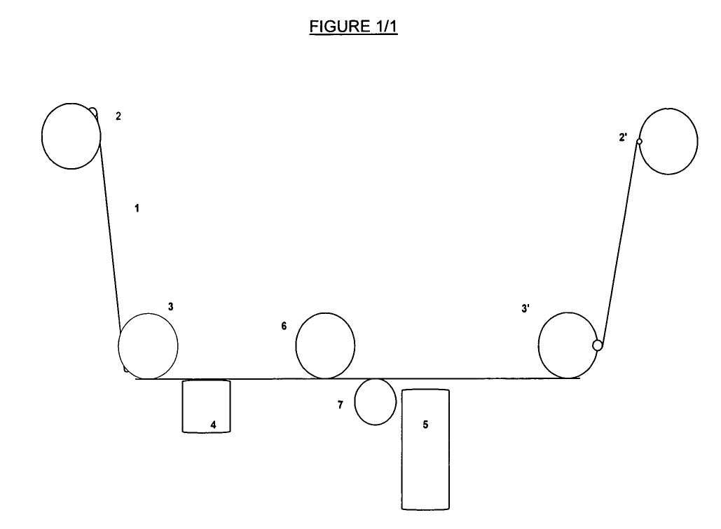

FIG. 1 is a schematic drawing of an apparatus in which the process of the present invention can be applied. In the drawing, (1) is the substrate, for example a film, which is rolled from bobbin (2) onto bobbin (2′). The film preferably is plasma or corona treated, which treatment can have been performed beforehand, or which can be done in-line (4). The film is guided by roles (3) and (3′). A cooling role could also preferably be placed more or less opposite to the outlet of the melamine evaporator. I that case, it could also act as a pressure roll. Vessel (5) represents the vaporisation vessel for the triazine compound, which triazine is applied onto the substrate layer.

The apparatus of FIG. 1 was housed in a vacuum chamber (not shown), that could be brought to a vacuum of 1-10·10⁻⁵ Pa. It is also possible to use two vacuum chambers with a thin slit to allow the substrate to move, one with the plasma treatment, and one with the triazine coating drum as this would allow different processing conditions in both compartments, and limits fouling of the triazine.

The invention will be further elucidated by the following non-limiting examples.

### EXAMPLES 1-2 AND COMARATIVE EXPERIMENT A

In an apparatus as shown in FIG. 1 coating experiments were performed. A biaxially oriented polypropylene film (BOPP) of 37 μm was plasma treated and coated with melamine at a vacuum of 50 μPa. The film speed was 5 m/sec. The films were laminated with a further plastic film (BOPP, one was reverse printed) in order to measure the lamination strength while using a urethane adhesive, solvent based with ethyl-acetate as solvent.

The lamination strength was measured according to JIS Z0238 with a Tensilon instron tester, at a speed: of 30 mm/min, the angle between the two films was 90 degree.

The Oxygen transmission rate (OTR) was measured with OXTRAN 2/20 manufactured by Modern Control Cop. In an atmosphere of 23° C. and 0 and 85% RH.

Vapor permeability was measured with a PERMATRAN 3/31 manufactured by Modern Control Co, I an atmosphere of 40° C. and 90% RH. Results are given in table 1

TABLE 1

| | Example | | |
|---|---|---|---|
| | 1 | 2 | A |
| In cc mm/m² day | Not Printed | Reverse printed | No melamine |
| Oxygen | 10.3 | 12.6 | 30.7 |
| transmission 0% RH | | | |
| Oxygen | 18.6 | nd | 31.9 |
| transmission 85% | | | |
| RH | | | |
| adhesion | 3.2 N/inch | 2.9 N/inch | Nd |

From these experiments it is clear that printing and moisture does slightly decrease the barrier properties of the melamine barrier layer.

### EXAMPLE 3

In an analogous way, a Polyetheleneterephthalate film of 12 micron (PET) was treated with melamine (300 nm). Next, the melamine layer was printed, causing a slight increase in transmission rates. Part of the printed layer was further laminated with an adhesive as described for example 1-2, and a propylene film. Another part was laminated with a polyethylenefilm in a direct extrusion process (the temperature of the die was 320° C.). The crystalline melamine layer could withstand the heating by the films so made (15-35 micron) and showed good lamination strength. The OTR was 0.5, the WVTR 2.

### EXAMPLE 4

In an analogues way laminates were made with a composite layer made as described in Example 2. In the further lamination, an adhesive was applied on the melamine layer, consisting of Novacote NC 275A and catalytic agent CA 12 (42.7 and 10.7 wt % respectively) and 46.6 % ethyl acetate. The adhesive had a percentage of solid of 40%. The OTR after lamination was 9.5. The lamination strength>2 N/inch.

### EXAMPLE 5

In an analogous way, a PET film was provided with a crystalline melamine layer. The initial OTR was 0.61 at 0% RH. After aging at 85% RH for 2 days, (where the OTR raised to 1.58), the OTR was only 0.08 when measured at 0% RH again.

### EXAMPLES 6 -8, AND COMPARATIVE EXPERIMENTS B AND C

The following coating compositions were made by mixing the components as shown in Table 2; amounts in parts by weight

TABLE 2

| Component | Coating I | Coating II |
|---|---|---|
| Polyester Uralac SN859 | 35.7 | |
| Polyester Uralac SN820 | | 35.7 |
| Cymel 325 (as 100% solid) | 11.6 | 11.6 |
| CAB 551.02 | 0.3 | 0.3 |
| Nacure 2500 | 0.4 | 0.4 |
| Sovent naphta 100 | 29 | 29 |
| Sovent naphta 150D | 28.6 | |
| Xylene/ethylbenzene | | 15.3 |
| Isopropanol | 0.6 | 0.6 |
| Isobutanol | 2.9 | 2.9 |
| Butylglycol | 10.4 | 3.3 |
| Appearance | Clear | Clear |

Uralac SN 859 and Uralac SN 820 are polyesters of DSM Resins, having an OH-value of about 50, an Mw of about 5000. Uralac SN 859 has a Tg of about 70° C., Uralac SN 820 has a Tg of about 7° C.
CAB 551 is a wetting agent.
Nacure 2500 is an acid curing catalysts.

A PET-film (Melinex S) of 23 μm thickness was coated with a continuous layer of crystalline melamine in a box coater by vapor depositing melamine, which was heated till 250° C. at a pressure of about 5*10⁻⁵ mBar. Thereafter, the coating was applied by roll-coating. The thickness of the coating was about 4 μm. Thereafter, the a laminate was made by applying a laminating adhesive, comprising NeoRex P900, Tolonate IDT, IPDI in butylacetate, applied in 12 μm thickness, and a casted polypropylene film of 30 μm thickness. Results are summarized in table 3.

TABLE 3

| | Coating | Laminating | OTR | OTR | |
|---|---|---|---|---|---|
| Example | composition | strength | At 0% RH | At 85% RH | Remarks |
| 6 | I | Pass | 1.3 | 1.0 | Stretch test |
| 7 | II | Pass | 2.3 | 7.5 | |
| 8 | none | Pass | 0.6 | 30 | OTR depends |
| | | | | | on the type of |
| | | | | | film |
| B | none | Not laminated | 1.4 | 45 | Coated with |
| | | | | | melamine |
| C | none | Not laminated | 65 | 50 | Not coated with |
| | | | | | melamine |

The OTR was measured with an OXTRAN 2/20 manufactured by Modern Control Co, according to their manual. The values given are the steady state values (generally) after 48 hr. The measurements were done at 23° C. The OTR is expressed as cc per m² per 24 hr.

The experiments show, that a bare PET film has an oxygen transmission of about 65 (Exp C). Applying a crystalline melamine layer does improve the OTR substantially (exp B), but at high humidity, the good barrier properties disappear. As is clear from the example 8, lamination improves the OTR at high humidity. Further improvement is achieved with crystalline melamine layer with a resin layer that is suitable for good oxygen barrier even at 85% RH. This makes this barrier film very suitable for transparent packaging.

The film of Example 6 was also subjected to a stretch test (5% stretch). Initially, the OTR raised to 13, clearly leaving part of the barrier properties intact. At 85% RH, the OTR was only 3.3, showing that the crystalline melamine layer was largely self healing due to the moisture.

1-26. (canceled)

27. Laminate comprising a substrate-layer and a plastic film and in between a crystalline triazine layer, the laminate having a lamination strength of about 2 N/inch or more as measured in a 90 degree tensile testing at 30 mm/min.

28. Laminate according to claim 27 wherein the laminate comprises an adhesive layer between the crystalline triazine layer and one of the plastic films.

29. Laminate according to claim 27 wherein the laminate comprises a printed pattern.

30. Laminate according to claim 27, wherein the OTR as measured in an atmosphere of 23° C. and 0% RH, is about 20 ml/m²·24 h·MPa or less for laminates comprising BOPP as a substrate, or about 5 ml/m²·24 h·MPa with PET as a substrate.

31. Laminate according to claim 27, wherein the water vapor permeability (WVTR) measured in an atmosphere of 40° C. and 90% RH is 2 g/m²·24 h or less for laminates comprising BOPP as a substrate, or about 5 g/m²·24 h or less with PET as a substrate.

32. Laminate according to claim 27, wherein the adhesion is at least 2.5 N/inch.

33. Laminate according to claim 27, wherein the adhesive has a Tg higher than 30° C. and lower than 200° C.

34. Laminate according to claim 32, wherein the adhesion is at least 3 N/inch.

35. Laminate according to claim 27, wherein the triazine compound is melamine

36. Laminate according to claim 27, wherein the substrate is plastic or paper.

37. Laminate according to claim 36, wherein the substrate is a plastic film.

38. Laminate according to claim 37, wherein the substrate layer is BOPP or PET.

39. Laminate according to claim 27, wherein a pattern or figure is present on the plastic laminating layer.

40. A laminate according to claim 27, wherein the grains in the crystalline melamine layer are about 300 nm or larger.

41. A laminate according to claim 40, wherein the laminate further comprises a cured resin layer.

42. A laminate according to claim 41, wherein the cured resin layer comprises—before cure—an azine or phenol type of resin.

43. A web comprising a laminate according to claim 27, further comprising a paper or cardboard web and a polyolefin layer on the other side of the paper or cardboard layer.

44. A web according to claim 43, wherein the laminate comprises a PET film, a triazine layer, optionally an adhesive, and a polyolefin layer.

45. A web according to claim 43 wherein the web comprises a printing or figure on the paper or cardboard web.

46. A rigid packaging comprising a folded and sealed web of claim 43.
